(19) United States
(12) Patent Application Publication
(10) Pub. No.: US 2009/0204524 A1
(43) Pub. Date: Aug. 13, 2009

(54) SECURITY SYSTEM

(76) Inventor: Jeffrey Bruce McGeorge, Queensland (AU)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/577,954

(22) PCT Filed: Aug. 30, 2005
(86) PCT No.: PCT/AU05/01305

§ 371 Date: Apr. 25, 2007

(30) Foreign Application Priority Data
Aug. 31, 2004 (AU) 2004100722

(51) Int. Cl. G06Q 40/00

(52) U.S. Cl. 705/35

(57) ABSTRACT

A credit card scanning protection system configured to send an electronic message to the cardholder's mobile phone (or other electronic device) when the cardholder's card is used in a transaction. In the event the cardholder receives notice of an unauthorized transaction, the cardholder can immediately call the issuing authority and query the transaction or have the card suspended. The system provides the card issuing authority with the ability to select and set rules relating to electronic message alerts. Examples include alerts for all cash withdrawals, transactions over a specified amount and transactions with a new merchant or in a new geographic area. The system also allows for customer interactivity whereby the cardholder can specify events which would govern the transmission of an electronic alert.

### TECHNICAL FIELD

The present invention relates to a security system which combines account activity monitoring and the field of information technology in mobile communications.

### BACKGROUND ART

Most organisations and individuals regularly use credit cards for obtaining goods and services.

Despite advancements in technologies and security systems in relation to cash or credit transactions, there remains a need for an economic means of detecting credit card fraud at the instant it is taking place.

In Australia alone, credit card fraud amounts to $140 million per annum causing a great deal of inconvenience to cardholders and financial institutions alike.

In Asia, it is reported that credit card fraud exceeds $1 billion per annum.

Most fraudulent transactions take place in the absence of the card where orders are placed for goods or services over the net or by telephone.

The majority of fraudulent transactions are for small amounts. However, accumulatively, losses are high with costs being passed onto cardholders in general through interest rates.

Whilst banks scan transaction patterns and will contact a cardholder when patterns are unduly changed and warn them that the line of credit will be cancelled if the cardholder does not contact them, this type of security can often back-fire particularly if the transactions are by the cardholder who may be on holiday and not able to respond to any bank communication.

Most cardholders are able to instruct the bank as to limits they wish to apply to their accounts to enhance security.

One example of this type of system is offered by St George Bank in Australia. The St George system offers a service whereby customers can automatically be sent account information they have requested via Short Message Service (SMS), including account balances, deposits and withdrawals as they occur, giving individual account holders greater control to better manage their finances.

The system proposes to give customers greater flexibility and peace of mind by providing information on how much money they have in their accounts when they have reached their credit or spending limits and whether any money has been taken out without their knowledge.

Under the system, customers have the option to have the following information automatically sent via SMS:
Account balances for any St. George Freedom savings account or credit card account
Notifications when account balances reach a predetermined high or low limit
Notification when the customer receives a deposit greater than a set amount
Notification when a withdrawal greater than a set amount is made from the account

The following are types of alerts under the St George system:

### Balance Alert:

Reports the available balance of the selected account at the beginning of the day.
Choice in the frequency of receiving the message from daily, weekly, fortnightly or monthly.
This will be sent at approximately 8.00 am EST.

### High Balance Alert:

Reports when the balance of a selected account reaches the predetermined value.
Where the High Balance alert is sent because of a transaction that occurred between the hours of 11.00 pm and 6.00 am, you will be notified at 8.00 am EST on the next business day
If the account balance changes due to a real time deposit, the message will be sent immediately.
This alert cannot be set as a re-occurring message.

### Low Balance Alert:

Reports when the balance of a selected account reaches the predetermined low limit.
Where the Low Balance alert is sent because of a transaction that occurred between the hours of 11.00 pm and 6.00 am, you will be notified at 8.00 am EST on the next business day. If the account balance changes due to a real time withdrawal, the message will be sent immediately
This alert cannot be set as a re-occurring message.

### Deposit Alert:

Reports when a deposit is received.
For transactions that occur between the hours of 11.00 pm and 6.00 am—you will be notified at 8.00 am EST the following morning
This alert type will offer the option to be set ‘recurring’.

### Withdrawal Alert:

Reports when a withdrawal occurs on your account.
For transactions that occur between the hours of 11.00 pm and 6.00 am—you will be notified at 8.00 am EST the following morning
This alert type will offer the option to be set ‘recurring’.

The major problem with this type of system is that the customer, while being allowed to set the individual triggers for which they wish to receive alerts, is limited in the types of triggers that can be used. As stated above, the type of alert which is directed towards minimising fraud on the customer is that the customer receives a notification when a withdrawal greater than a set amount is made from the account. This type of trigger is helpful when the customer wishes to set a limit on the amount which they wish to withdraw without triggering an alert but is less helpful when the practice of “skimming” is used against the customer.

Skimming is a practice used by more advanced fraudsters and it is based around the fraudsters mimicking the spending or withdrawal patterns of a customer, thereby the withdrawal affected by the fraudster is not recognised as being abnormal to the customer or the scanning system in place. Skimming is normally accomplished using a Palm Pilot-size hand-held device that can read and store all the encrypted data embedded within a card's magnetic stripe, as well as the name, number, expiry date and other information. The data can then be copied onto counterfeit cards that mimic the original card in order to bypass the security screens of the financial institutions authorising the transactions.

An example of “skimming” is illustrated in FIG. 1. The figure shows a list of transactions taking place on a customer's account, be it a credit card account or otherwise. The “skimmed” transaction is displayed as transaction “C”. As can be seen, the amount of the skimming transaction is a relatively small amount compared to the other transaction listed and as such, would not be identified using a limit-type alert system such as the St George system. Transaction “D” is more likely to be recognised as an abnormal transaction given the large amount when compared to the relatively small amounts processed prior to transaction D, even though transaction D is an authorised transaction executed by the owner of the account.

“Skimming” uses unauthorised low amount/high volume transactions in order to defraud the cardholder. The amounts, being smaller, are not identified as unauthorised by prior art systems and therefore the cardholder is not alerted to the unauthorised transactions until a statement is received or checked and by that stage, the fraud has already been visited upon the cardholder and it is too late.

Current fraud prevention technology does not cater for skimming, CNP (Card Not Presented fraud) or any other fraudulent use of the card, that involve seemingly genuine debit requests presented to be approved by neural networking technology systems, which attempt to determine whether the debit request belongs to the true card owner, by comparing previous spending habits against the current debit request. This process is tantamount to gambling or guessing, using probability and other neurally derived techniques to create a decline/accept response, because the one person who knows whether the debit request is fraudulent or not, the genuine card owner, has no changeable parameter input, which can be preset to query and filter or block the pending transaction request in order to stop fraudulent transaction requests becoming authorised transactions in their accounts. Genuine card owners have also experienced their own unusual transaction requests being blocked, unusual being in the eyes of the neural networking systems because genuine card owners are human, and humans are prone to abnormal decision-making and behaviour. Unfortunately, neural networks are designed to alert to unusual transaction requests, that is transaction requests that are unusual compared to the previous transaction pattern history of the account. If the request is deemed to be suspicious enough to query and decline, this stops the genuine card owner from using their card until they contact their bank and address the situation.

Other forms of fraud are continually developing. In a phishing attack, a fraudster spams the Internet with email claiming to be from a reputable financial institution or e-commerce site. The email message urges the recipient to click on a link to update their personal profile or carry out some transaction. The link takes the victim to a fake website designed to look like the real thing. However, any personal or financial information entered is routed directly to the scammer.

In a Trojan Attack, an attacker gets the Trojan installed on a user's computer. When the user logs into his bank's website, the attacker “piggybacks” on that session via the Trojan to make any fraudulent transaction he wants.

Two-factor authentication has been used in an attempt to overcome these new forms, as has using two different communications paths. One bank sends a challenge to the user's cell phone via SMS and expects a reply via SMS. If it is assumed that all the bank's customers have cell phones then this results in a two-factor authentication process without extra hardware; and even better, the second authentication piece goes over a different communications channel than the first; making eavesdropping much more difficult. Two communications paths do not however solve the problem if the challenge code is sent whilst the user has not completed the transaction or group of transactions, particularly with regard to “piggybacking” as the fraudster is still “in the system” and can see the code come back in. They can then attach fraudulent transactions to the user's valid code.

An attacker using a man-in-the-middle attack is happy to have the user deal with the SMS portion of the login, since he cannot do it himself, and a Trojan attacker does not care, because he is relying on the user to log in anyway.

Once a fraudulent transaction has been processed by a financial institution, in order to have the transaction reversed, the financial institution has dispute resolution procedures. The dispute resolution procedures have a cost attached of approximately $70 per transaction to reverse, including account fees, time and processing charges. This amount is in addition to the amount actually lost to the financial institution due to the fraud. There is also a further cost to the financial institution in the dissatisfaction created in the mind of the customer. The customer is more likely to draw an adverse opinion of the financial institution due to the fraud and is more likely to advise others of this adverse opinion.

It is an object of the present invention to provide a security system which will reduce transaction fraud whether card not presented fraud or over a remote media such as internet banking; and also which may at least partially overcome at least one of the abovementioned disadvantages or provide the consumer with a useful or commercial choice.

Further objects and advantages of the present invention will become apparent from the ensuing description which is given by way of example.

According to the present invention, there is provided a method of monitoring and confirming account usage, the method comprising the steps of:
(a) a principal entering into an agreement with a service provider to provide real-time account activity monitoring service, wherein the principal communicates to the service provider transaction criteria upon which the principal is not to be alerted,
(b) the service provider monitoring account activity using at least one computer, and
(c) the service provider providing a real-time message to the principal via a remote communications device (RCD) when authorisation for a transaction which does not match the principal's transaction criteria is requested.

In an alternative form, the invention may reside in a method of monitoring and authorising account usage, the method comprising the steps of:
(a) a principal entering into an agreement with a service provider to provide real-time account activity monitoring service, wherein the principal communicates to the service provider transaction criteria which the principal is to monitor,
(b) the service provider monitoring account activity using at least one computer, and
(c) the service provider subjecting transactions to a pre-authorisation procedure which includes comparison with the principal's criteria.

Authorisation for the transaction may be dependant upon the satisfaction or contravention of the principal's criteria which will typically be required before authorisation for the transaction is given. If the principal sets a pre-authorisation condition then the transaction will preferably be blocked before authorisation if the condition is not satisfied. In other words, the transaction will be declined.

The service provider will typically monitor the pre-authorisation data packets between a financial institution and a point of sale terminal. An alert may be sent to the principal notifying the principal of a contravention of the principal's conditions and a refused or blocked transaction request. According to a preferred embodiment of this aspect of the invention, the principal may communicate their criteria upon which monitoring is to take place to the service provider using a computer network and typically using an HTML interface. The principal may also issue a confirmation code for a temporarily blocked transaction and request that the user return the code to authorise the transaction. This may occur along the same or different communication paths to the same or multiple RCD's. Generally, one or both communications paths will be secured and may possess identification such as Automatic Number Identification/Calling Line Identification (ANI/CLI) authentication

The present invention allows the principal (cardholder) to set parameters that allow only their authorised debits to occur because the principal is the one person who knows whether the pending debit request is theirs or not. This therefore allows the bank, the merchant and the cardholder to stop all unauthorised access to the principal's accounts.

When a credit card is used, the card is generally swiped through a reader or similar machine with a communications connection and the details of a transaction are then entered. The transaction is then processed. During processing, the reader uses the communication connection to request authorisation from the credit card agency or bank. Authorisation is generally given dependant upon the satisfaction of general parameters such as the transaction amount not exceeding the credit limit and/or the card being valid and the like. The system of the present invention may operate as a further part of this authorisation process. The system may be associated with the data feed used during the authorisation process and the satisfaction or contravention of the principal's criteria communicated to the service provider may be a further parameter which may be required before authorisation for the transaction is given. If the principal's criteria is satisfied then the alert or notification will not be sent.

The system of the present invention may differ from the prior art systems in that the principal has a much broader scope of criteria which will trigger the alerts. Instead of requesting that alerts be sent in particular situations, the principal may communicate their anticipated transactions to the service provider and the service provider alerts the principal at every transaction which does not correspond to the principal's criteria. The system of the present invention may be used in combination with a prior art system of specifically requested alerts or separately therefrom.

Typically, the service provider may use a network of more than one computer to monitor the activity. The network as a whole may be termed a central data server and usually comprises a number of drone computers.

Typically, the system of the present invention will be used to monitor credit card activity but it may be used to monitor any type of account, particularly since the advent of various types of remote banking such as Internet banking and the like. Information relating to the use of an individual credit card forms a part of a data feed. When a card is used, the information relating to the transaction is transmitted to a central point, usually a credit agency or a bank. The information may then be stored in the bank or credit agency's database. The system of the present invention may be associated with the bank or credit agency data feed.

The remote communications device can comprise the cardholder's fixed or mobile telephone, a personal computing device or a facsimile or pager of the cardholder. All of these devices and others which are not listed but are included as a remote communication device can generally have a software component.

The cardholder can communicate to the principal the criteria upon which monitoring is to occur or alerts are to be sent. One particularly preferred embodiment of the criteria may be a user or principal providing a list of Merchant codes at which the credit card will be used over a set time period. The service provider may then monitor the merchant codes and alert the principal when authorisation of a transaction with an anomalous merchant code is requested. Other information or criteria may be used by the principal to trigger the alert such as use of the card at a particular merchant outside a geographical location. A particularly narrow set of information may be provided by the principal including all of the principal's proposed spending including dates and/or locations, on the card in a set time period. In this way, the service provider may alert the principal when authorisation for a transaction not matching the specific transactions listed by the principal is requested.

The cardholder's RCD software component can be used to send input commands to a software environment that is running on the network of computer systems of the service provider.

In response to the input command, the software environment sends a local input command to a software environment component that processes the commands which responds by issuing a local output command to a server infrastructure which in turn sends a remote output command to the cardholder's RCD.

In response to remote output commands, the RCD can cause an alert output to be issued or displayed on or to the RCD.

A plurality of integrated and related systems can be provided to achieve information transfer.

The systems and relationships for information transfer can be as follows;
(i) From an Internet software, WAP enabled phone or mobile input device.

The cardholder sends a message or command from a remote communications device which is directed to the central data server but must generally pass through or be intercepted by a scanning system and/or a switching box. The switching box may form part of the central data server network.

The message may contain data including information about how to set up the cardholder's watches, the type of activity to be monitored as well as information on regular patterns of use of the card, requests for specific data or login information.
(ii) The scanning system may generally receive all messages sent from any computer or device connected or connecting to the system.

The scanning system generally performs at least one but generally a set of security tests on the information requested or submitted to the central data server. These tests are generally called security protocols. If the information requested or submitted is within the ambit of the security protocols, the scanning system may grant access to a secure level (Authorisation level 2) which prevents unauthorised manipulation of the data held or accessed by the central data server.

Once access to authorisation level 2 has been granted, the information may be directed to a switch box to be processed.

The function of the switch box can be to:
(1) find the least busy drone computer within a network to process a specific command or watch;
(2) route alerts to an SMS (short message service) server to be sent to cardholders' computers or mobile handsets;
(3) send requested information between drone computers.

The switch box may be the centre of the system. It generally allocates the workload for each of the drone computers within the central data server and is generally also responsible for the release of alert messages and exchange of information between elements of the system.
(iii) Drone computer systems as part of the network are each connected via a local area network using the TCP/IP protocol (internet protocol). The drones are directly connected to each other to form the network and/or the credit card agency data server and the bank data server. The drone computers may preferably have two main purposes; they are as follows:
(1) to accept, process and return data which a cardholder has requested from the service, and
(2) to repetitively calculate cardholders' requested “watch data” (an event set by the cardholder to trigger an alert which is sent to the cardholder's mobile or RCD).
(iv) Communication server software receives a message from a drone computer routed through the switch box.

Once the Communication server software receives the message, the Communication server finds the corresponding cardholder's data (i.e. telephone number, name) and passes the message as well as the correct phone number to send the message, to an SMS communications device.
(v) An SMS communications device receives a message from the Communication server and broadcasts it to the remote communications device.

In an alternative embodiment of the present invention, one or more “history servers” can be added, the purpose of which is to provide data to any of the computers connected to the network.

The history server is in place so that it can act as a gateway to the data feed.

The history server scoops all of the data out of the data feed as it comes along so that the data never needs to be requested from an outside source more than once. Once the data is collected from the data feed or from the bank or credit agency database, the history server may store the data in its own database to prevent the need to request the same information numerous times.

All servers connected to the network request their data from the history server.

The drones may be no longer directly connected to the data feed but instead may be connected to the switch box and request their data from the new history server through the switch box.

A central data storage may be created to house the databases created by the history server.

Each history server connected to the system can then use these databases (located on another computer) so that cohesion remains throughout the network.

One important aspect of the present invention may also be the method by which a principal can make unanticipated transactions and notify the service provider so as not be alerted to the transaction or have the transaction blocked. In this aspect, the system may be adapted to allow the principal to notify the service provider that authorisation for an unanticipated transaction is about to be requested and that an alert need not be sent. This notification of an unanticipated transaction will typically be the subject of rigorous control to prevent corruption or unauthorised access and tampering with the system as this may allow fraud to be visited upon the principal. There may be various levels of security or steps which have to be followed in order for a principal to advise the service provider of the unanticipated transaction and stop the alert and/or block the transaction including, but not limited to, the principal communicating an access code to verify their identity. The access code or authorisation code may be generated by the service provider or the bank or a third party and transmitted to the principal. The code will typically be transmitted on a first communications path and the returned authorisation typically requires the transmitted code to be returned. This return step can be performed along the first communications path but for further security, will generally occur along a second communications path, separate from the first. Each communications path will typically be to a separate remote communications device, requiring a fraudster to have access to more than one of the principal's RCD's.

A part of the alert, code or message sent to either of the principal's RCDs may include a list of the pending transactions, preferably including at least those which are to be blocked according to the parameters of the principal and which may be authorised using the system of the present invention.

The service provider may then contact the principal on their chosen remote communications device (RCD) (which may be the same as the RCD used to conduct transactions or a different RCD) to confirm or authorise the transactions. Suitably the communication process may be accomplished via the same system through which the alert is issued. Generally, the notification may amend the principal's criteria for blocking or alerts. This amendment may occur on a temporary or time-controlled basis or may take effect until the principal submits a further amendment to the criteria.

The system of the present invention therefore provides for the use of an alternate and trusted channel for the verification and authentification of transactions. The system preferably makes use of an second channel for the verification of transactions which are conducted on a first channel, in the preferred embodiment, through the use of the PSTN telephone and/or mobile/cell telephone networks.

The CAPS system appears well suited for the supply of an alternate, trust channel to enable end-users to:

Verify that their Internet session has been with the enterprise, e.g. the bank, that they assume they have been connected to for the formation of transaction requirements,

Verify and authorise transactions on an individual or “batch” basis;

Verify and authorise transactions on the basis of a set of parameters set by the end-user in conjunction with their transaction server, e.g. the bank;

Trust in the channel used to perform authorisation as that channel will only be known by the server system and the client, e.g. a pre-stored landline or mobile/cell phone number and will involve a hight trust network, i.e. the PSTN or mobile/cell phone network subject to extensive legislative security requirements;

Trust in the content of the transactions as the content is made known to the end-user, e.g. by a synthetic voice generator that pronounces each transaction audibly for verification; and

Verification is performed using a “handset” possessed only by the end-user, e.g. their own mobile/cell phone.

In another form, the invention resides in a method of monitoring and authorising account usage with multi-factor authentication, the method comprising the steps of:
(a) a principal entering into an agreement with a service provider to provide real-time account activity monitoring service, wherein the principal performs at least one transaction using a first communication pathway,
(b) the service provider monitoring account activity using at least one computer, and
(c) the service provider subjecting the at least one transaction to a pre-authorisation procedure which includes communication to principal of confirmation information and the principal sending confirmation of the transactions using a second communications pathway.

### BRIEF DESCRIPTION OF THE DRAWINGS

Aspects of the present invention will now be described with reference to the accompanying schematic drawings in which;

FIG. 1 is a transaction listing with an example of a “skimming” system in place.

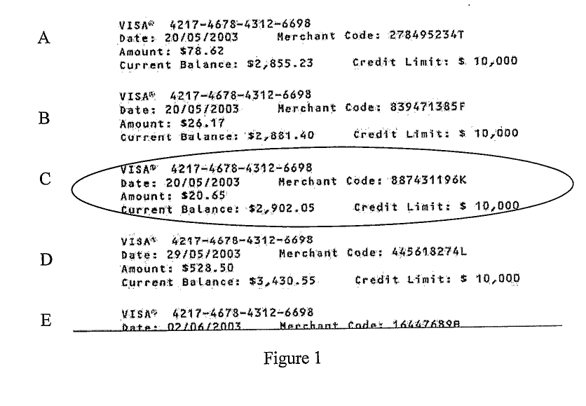

FIG. 2 is a schematic illustration of a preferred embodiment of the system according to the present invention.

FIG. 3 is a schematic illustration of a preferred embodiment of the an internal server infrastructure used according to the system used in FIG. 2.

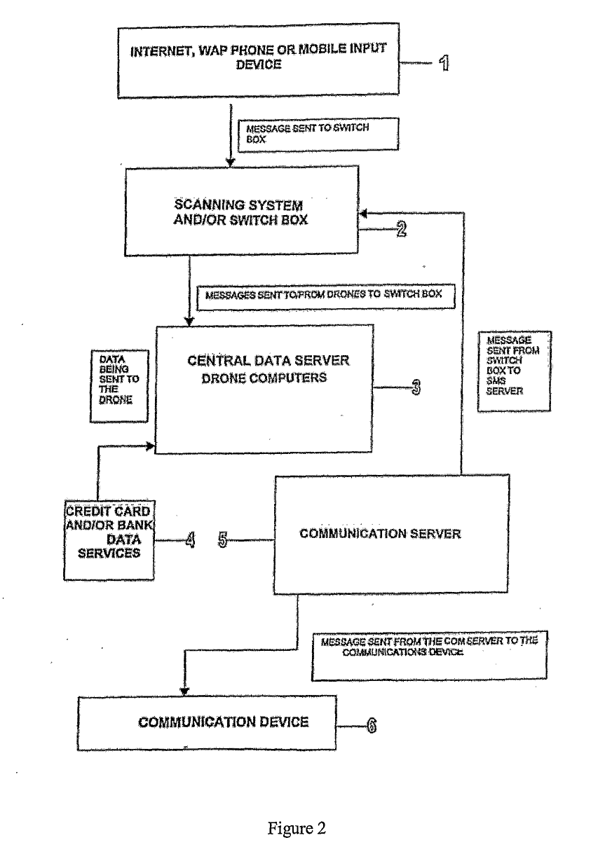

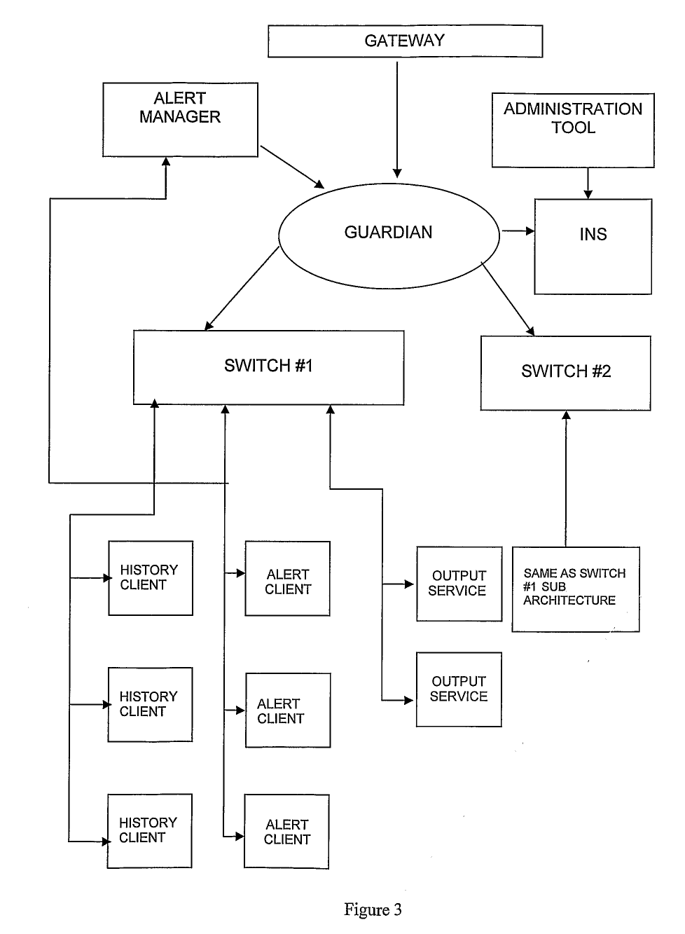

With respect to FIG. 2 of the drawings, element 1 sends a message directed to the central data server but the message is intercepted by the scanning system 2 and/or switch box. The message relates to the kind of data to view or what kind of indicators to add to a cardholder's usage patterns.

Element 2, the scanning system, receives the message from the Internet, a WAP-enabled phone or mobile input device. It then applies security protocols to the message to ascertain whether the information transmitted or requested is authorised information. If the security protocols are satisfied, the message passes to authorisation level 2 and is allowed to proceed.

The message proceeds to the switch box shown in the schematic illustrations as a part of the scanning system. The switch box then finds the least busy drone computer within the central data server network and sends the message to that computer to be processed.

The switch also processes logins and logoffs of the Communication server, drone computers and remote access.

Element 3 represents the central data server which is a series of computers connected via a network (LAN) which is also connected to the credit card agency data server, the bank data server and switch systems.

The drone processes messages from the cardholder (sent via the switch). These messages are requests to monitor usage patterns for irregularities. The drone computer then analyses the data available to it and applies the cardholder's chosen usage patterns, both past and present, to the data. If the data elicits a positive response (e.g. the current usage is irregular), the drone computer sends a message to the switch box which then sends it to the communication server.

Data from element 4 is fed from the credit card agency data server or bank data server to the drone computers (when requested to do so by the drone computer).

Element 5 receives a message from a drone computer which is routed through the switch box.

The message tells the communication server to find out what phone or remote communication device to send a message to.

The communication server then contacts the appropriate communications device and tells it to send the appropriate alert.

Element 6 receives the message from the communication server and broadcasts it to the remote communication device identification number sent to it from the communication server.

With respect to FIG. 2 of the drawings, an internal server infrastructure can comprise the components illustrated and described below;

Gateway: The gateway is one of two parts directly connected to the Internet. It allows cardholders and network appliances to connect to their correct server.

Guardian: The guardian keeps track of all major servers on the network; major servers being single within the given locality. The guardian also has the ability to funnel small amounts of data from load management tools and administrator tools directly to the switchbox for routing and processing.

Alert Manager: The alert manager stores and distribute all created alerts to the least busy drone computer.

Administration Tool: The administration tool allows a third party administrator to connect to the system and edit, remove or add cardholders without interrupting the flow of data around the rest of the system.

INS: The INS stores all of the cardholders' details, including cardholder names, passwords and financial data. The INS is a request-only server from the service provider side of the network and data inside it can only be changed from the administrator tool.

Switch: The switch server(s) is a routing device which routes information packets from one server to the other. Any switch's main job is keeping the network free from traffic bouncing between many erroneous servers before getting to its destination. Switchboxes are also used to apply “load balancing” to components of the network which are connected to it.

History Client: The history client(s) contain a large database of credit card usage data which is stored every time a transaction is made on the credit card. The history client is a request-only client which feeds data from itself to the requesting party, be it an internal server or external device.

Alert Client: The alert client(s) do all of the mathematical calculations for alerts currently running on the system. The alert client(s) requests data from the history client(s) and processes that data through a series of events. The alert client(s) is responsible for generating the final alert which is sent via the output service.

Output Service: The output service is the network connection software and hardware which connects the network of computers to an output device.

An outline of the steps occurring to prevent fraudulent activity occurring in an online banking environment according to a preferred embodiment of the present invention, are as follows:

1/ User logs in generally using their account no. and password.

This step is open to attack by fraudsters who either piggyback on the user's entry to gain access or who have set up a fake internet site to gain the account no. and password.

2/ User Organizes payment of bills.

Once a Trojan has been used, the fraudster can “see” all activity that the user engages in. If a man-in-the-middle attack is used, the fraudster can use the account details of the customer to perform transactions.

3/ User saves payment schedule, which generates a one time payment code and forwards code to user along a first communication path.

This code accomplishes two outcomes, namely indicating to the system that the customer has completed their transactions, which prevents a Trojan type attack whereby a fraudster can add transactions to those performed by the customer and have them linked to the same payment code, and also by sending it to the user, the user can use the code along a second communication path. (stops “piggybacking” of fraudulent debits)

4/ Code is entered into the bank's system from the user's remote communications device via Interactive Voice Response system or Short Message Service along a second communications path. Typically, the code is not accepted unless entered from a pre-authorized phone number that corresponds to the user's remote communication device Automatic Number Identification/Calling Line Identification (ANI/CLI) number or code.
5/ The System is unaffected by spoofing, because the system blocks all unrecognised transactions which do not correspond with the user's transaction parameters and further, only passes unrecognized transactions which the user has authorized using the payment code sent from a pre-authorized phone number that corresponds to the user's remote communication device with a particular ANI/CLI number.

Automatic Number Identification/Calling Line Identification (ANI/CLI) authentication is the authentication of a connection attempt based on the phone number of the caller. The ANI/CLI technology allows telecommunications service providers to identify which telephone line (each is assigned a unique number) is making the call in order to correctly charge consumers for the call service.

There are two major advantages of the present invention;
(1) Usage analysis indicators can be applied to a cardholder's past or present usage data and boasts programming which can inform a cardholder of an “indicated” signal to do whatever the indicator was designed to inform the cardholder of, without the cardholder having to ponder over the data themselves.
(2) Usage analysis indicators can be set to “repeat” over a certain period and can be told to alert the cardholder when an “event” happens via wireless or non-wireless technology wherever the cardholder may be.

The features of the system which result in the advantages mentioned above are as follows:
(1) The system is accessible and active at virtually all times, all day, everyday.
(2) The system can more quickly apply thousands of different or related parameters and/or specified patterns to credit card usage data.
(3) The system is more accurate and mathematical in its interpretation of results.
(4) The system can be designed to be “set” and “run” (e.g. the cardholder sets up their indicators and can be alerted of them until it is told to be stopped).

A particular embodiment of the invention is described in the instruction manual and system description included as ANNEX 1 and forming part of the specification.

In the present specification, when the term “credit card” is used, it is intended to encompass use of the card itself or of identification means of the credit card allowing remote use of the card.

Aspects of the present invention have been described by way of example only and it will be appreciated that modifications and additions thereto may be made without departing from the scope thereof.

ANNEX 1

1. A method of monitoring and confirming account usage, the method comprising the steps of:
a. a principal entering into an agreement with a service provider to provide real-time account activity monitoring service, wherein the principal communicates to the service provider, transaction criteria upon which the principal is not to be alerted,
b. the service provider monitoring account activity using at least one computer, and
c. the service provider providing a real-time message to the principal via a remote communications device (RCD) when authorisation for a transaction which does not match the principal's transaction criteria, is requested
d. wherein at least two communications paths are used, a first communication path for the transaction and a second communication path for the issue of the confirmation code, such that a fraudster is required to have access to both communication paths in order to commit fraud.

2. A method according to claim 1 wherein the transaction is blocked at 20 least temporarily when authorisation for a transaction which does not match the principal's transaction criteria is requested.

3. A method according to claim 1 wherein a first RCD and a second RCD are used, the first RCD is used by the principal to conduct a transaction and the second RCD is used to receive the message.

4. A method according to claim 3 wherein the message contains a confirmation code which the principal can send to the service provider to confirm the transaction.

5. A method according to claim 4 wherein the confirmation code is generated when the principal performs an action which indicates that the transaction is 30 complete.

6. A method as claimed in claim 1 wherein the remote communications device comprises the principal's fixed or mobile telephone, a personal computing device or a facsimile or pager of the principal.

7. A method as claimed in claim 1 wherein the service provider uses a network of computers or computer systems to monitor the account activity.

8. A method of monitoring and authorising account usage, the method comprising the steps of a principal entering into an agreement with a service provider to provide real-time account activity monitoring service, wherein the principal communicates to the service provider transaction criteria which the principal is to monitor, the service provider monitoring account activity using at least one computer, and the service provider subjecting transactions to a pre-authorisation procedure which includes comparison with the principal's criteria

9. A method according to claim 1 wherein the real-time message from the service provider contains a code and the principal can authorise the transaction by returning the code to the service provider.
